(19) United States
(12) Patent Application Publication
(10) Pub. No.: US 2005/0217099 A1
(43) Pub. Date: Oct. 6, 2005

(54) Devic and process for producing a pre-form assembly

(76) Inventors: Alexander Egidi, Parkstetten (DE); Karl-Heinz Fueller, Neu-Ulm (DE)

Correspondence Address: PENDORF & CUTLIFF, 5111 Memorial Highway, Tampa, FL, 33634-7356, US

(21) Appl. No.: 11/096,000

(22) Filed: Mar. 31, 2005

(30) Foreign Application Priority Data
Mar. 31, 2004 (DE) 10 2004 016 460.6

(51) Int. Cl. B21B 27/06; B23P 11/00

(52) U.S. Cl. 29/430; 29/429; 29/711; 29/791; 29/795

(57) ABSTRACT

The task of the present invention is comprised in providing an economical device for the positionally precise modular production of a pre-form assembly (10) as well as a process for improving the economy of the production of a pre-form assembly (10). This task is solved by a process and a device for producing a pre-form assembly (10) for a vehicle with at least two pre-form modules in which first a deformation of at least two blanks into rolled sections occurs and then a further processing of the rolled sections into pre-formed modules occurs, wherein: the deforming of the blanks occurs in at least two parallel devices for production of a rolled section, the further processing of the rolled sections occurs in at least two parallel production facilities,
a control device, connected with the at least two devices for production of a rolled section and with the at least two production facilities and with a further processing facility, controls these in such a manner that the pre-form modules are joined into a pre-form assembly (10) chronologically and spatially coordinated in a further processing facility.

### BACKGROUND OF THE INVENTION

1. Field of the Invention

The invention concerns a device for producing a pre-form assembly according to the pre-characterizing portion of Patent Claim 1 and a process for producing a pre-form assembly according to the pre-characterizing portion of Patent Claim 6.

2. Related Art of the Invention

It is known in motor vehicle construction, in particular utility vehicle construction, that a pre-form assembly is provided for a vehicle, in order to mount various vehicle components such as, for example, body, motor, mounting systems, etc. The pre-form assembly typically includes a pair of parallel longitudinal members as main chassis beams extending in the longitudinal direction and generally extending along the opposite sides of the vehicle, a number of transverse cross beams which connect the longitudinal members with each other along spaced-apart positions, and a number of door sills or rocker pannels, which are connected with the parallel longitudinal members. The pre-form assembly functions as the main load-bearing component with regard to stiffness and rigidity, in contrast to body parts which are typically employed in conventional passenger motor vehicles.

In the production of a pre-form assembly for vehicles the manufacturers typically employ deep draw or roller processes, in which steels, such as for example deep draw steels, are deformed into the desired carrier structures.

From DE69504857T2 a process for production of a pre-form assembly for a vehicle is disclosed using various deformation processes such as, for example, internal high pressure deformation (IHD), stamping and rolling. The pre-form assembly is comprised of three parts: the front frame module, produced using internal high pressure deformation (IHD), the central frame module, produced by roller profiling, and the rear frame module, produced by stamping. These individual frame modules are produced in a number of deformation processes, since it is difficult to produce different frame module geometries and dimensions using only roller profiling in one work process. The joining of the frame modules into a pre-form assembly occurs later and separately. The employment of multiple deformation tools limits the economic viability of the deformation process, since increased investment costs are needed for the tools and machines, for personnel and for quality control. In addition, since there is no just-in-time manufacturing of the roller profiles in the individual deformation processes, there is a stockpiling, leading to unnecessary logistic and transport costs for the individual rolled sections. Further, it is a problem in this pre-form assembly that this is comprised of multiple modules, as a result of which the roller profiled sections, in particular the longitudinal members, exhibit a reduction in stiffness in the joint areas, negatively influencing the torsion and bending stiffness.

### SUMMARY OF THE INVENTION

Beginning with this state of the art, it is the task of the present invention to provide an economical device for modular production of a pre-form assembly as well as an economically optimized process for production of a pre-form assembly.

With regard to the inventive device having the characteristics of the pre-characterizing portion of Patent Claim 1, this task is solved by the characterizing features of Claim 1 and with regard to the process with the characteristics of the pre-characterizing portion of Patent Claim 6 this is solved by the characterizing features of Claim 6. Further advantageous designs and improvements of the invention can be seen from the dependent claims and the description.

The inventive solution is provided by a device for production of a pre-form assembly for a vehicle with:
a device for production of rolled sections and
a production facility for further processing of the rolled sections into pre-form assemblies,
   thereby characterized,
   that the device for production of the pre-form assembly further includes:
at least a second device for production of rolled sections connected parallel to the first,
at least a second production facility for further processing, connected parallel to the first,
at least an additional production facility for joining the pre-form modules into a pre-form assembly, and
at least one control device for controlling the supplying and/or joining of the at least two pre-form modules into a pre-form assembly.

One advantage of the inventive device for production of a pre-form assembly is comprised therein, that all process steps can be carried out on a single device, which includes multiple devices for production of rolled sections and production facilities, wherein the devices for production of rolled sections and the production facilities are coordinated to each other, whereby an increase in output and a savings in time results. A high unit output per time produces a high economy of the inventive device for production of a pre-form assembly.

In accordance with the invention, the transport of the rolled sections, for example to a separate production facility or a deformation line, can be omitted. The known logistic problem, which is associated with conventional devices for production of rolled sections, is solved in accordance with this invention.

A further advantage of the inventive device is comprised therein, that thereby an improved precision of positioning of the rolled section, the pre-form module and the components is ensured, since the repositioning on a new, separate device can be dispensed with. Thereby the pre-form assembly exhibits an increased dimensional reproducibility and precision.

Another advantage of the inventive device lies therein, that similar rolled sections, which differ for example only in their length, can be modularly produced, without set-up changes or separate sets of tools, by simply modularly appropriately changing the length at the end of the device for production of a pre-formed assembly. Therein longitudinal members, cross beams and door sills are standardized and differ in length and depending upon the vehicle model, wherein the roller profiled cross-section of the individual cross beams and the rocker panels or door sills have the same shape.

In one advantageous embodiment of the invention the device for production of a rolled section includes at least one integrated production facility for deformation, wherein the production facility is adapted to change the roller profiled cross-section.

The advantage of this design is comprised therein, that rolled sections with roller profiled cross-sections strongly differing from each other can be locally deformed in a device for production of a rolled section by means of a production facility for deformation integrated into this device for production of a rolled section, in particular a deep draw production facility and/or a production facility for creasing or crimping, without having to undertake expensive set-up changes and device changes.

Therewith parallel rolled sections can be produced in this embodiment of the invention in the device for production of a rolled section, which exhibit changes in roller profiled cross-section strongly deviating from each other. These are further processed into pre-form modules and subsequently are joined into a pre-form assembly. Therein the transport of the rolled section to a separate deformation line can be dispensed with, since all process steps are carried out on a single device for production of a pre-form assembly and therewith an increase in unit output per time is accomplished.

It is also possible to produce, with this device for production of a rolled section, rolled sections with the same roller profiled cross-section, and to join these with others into a pre-form module.

In a further embodiment of the invention at least two devices for production of a rolled section are interconnected synchronized.

The advantage of a synchronized interconnecting is comprised therein, that the two devices for production of a rolled section can simultaneously produce rolled sections with the same or with strongly divergent roller profiled cross-sections. By the time savings associated therewith the output is increased.

Alternatively thereto, the devices for production of a rolled section can be interconnected asynchronously and thus operated discontinuously. This discontinuous operation makes possible the parallel simultaneous production of rolled sections which are producible with a low number of process steps in different devices from the devices for production of rolled sections with a higher number of process steps, and to join these with each other into a pre-form module at a predetermined point in time.

In a different embodiment of the invention at least two processing facilities are interconnected synchronized to each other or to the device for production of the rolled section.

One advantage of the synchronized interconnecting of production facilities is comprised therein, that the production facilities can be controlled in a continuous operation with the same cycles of the devices for production of a rolled section. Therewith the rolled sections are produced in one work process with savings of time without intermediate storage and therewith without the associated logistical and transportation expense.

Alternatively or additionally it is possible to have at least two production facilities interconnected asynchronously. This discontinuous operation makes possible the application of complex roller profiled cross-section variations to intended areas of the rolled section.

In a further embodiment of the invention the device for production of a rolled section supplementally includes at least one interconnected production facility for straightening or truing and/or one interconnected production facility for marking and/or one interconnected production facility for joining and/or one interconnected production facility for crimping and/or interconnected production facilities for drawing or pressure-forming and/or an interconnected production facility for introducing holes and/or an interconnected production facility for washing.

One advantage of this special device for production of a rolled section lies therein, that by means of this interconnected production facility the roller profiled cross-section can be stepwise deformed, so that a convenient fitting together via the roller profiled cross-section can be established. Supplementally the synchronous and/or asynchronous interconnecting of the production facilities makes possible a step-wise deformation of a blank into a rolled section or, for example, a deformation of the blank into a rolled section in one work process.

Alternatively or additionally to this embodiment, a production facility for washing can be provided separately subsequent to the production facility for further processing of the rolled section into pre-form modules.

A further object of the present invention concerns a process for production of a pre-form assembly for a vehicle with at least two pre-form modules, with the following coordinated steps:
deforming at least two blanks into rolled sections,
further processing the rolled sections into pre-form modules,
wherein the deformation of the blanks into rolled sections for the pre-form modules to be joined occurs in at least two devices for production of a rolled section arranged in parallel,
wherein further processing of the rolled section into pre-form modules occurs in at least two parallel production facilities, and
wherein a control device is connected with the at least two devices for production of a rolled section and with the at least two production facilities and at least one further production facility, for controlling in such a manner that the pre-form modules are joined, coordinated in space and time, into a pre-form assembly in the further processing device.

One advantage of the inventive process is comprised therein, that from rolled sections pre-form modules can be produced, which are joined to a pre-form assembly, since the positioning upon a new, separate device is omitted. Thereby the dimensional truness and the dimensional precision of the pre-form assembly is increased.

One further advantage of the inventive process is the modular production of rolled sections, which exhibit different roller profiled cross-sections in their height and in their breadth, and are produced in time saving manner on a device by continuous or discontinuous roller profiling. Therein logistical and transport expenses are avoided, whereby the economy of the process is increased.

One further advantage of the inventive process is comprised therein, that by the uninterrupted roller profiling, the carrier stiffness reduction in particular in the joined area is avoided by this design engineering. Accordingly the pre-form assembly produced in accordance with the invention is characterized by high torsional and bend stiffness or rigidity.

A further embodiment of the inventive process is the production of a pre-form assembly of high and higher strength steels, preferably with a tensile strength of up to 1,700N/mm², which is appropriate for the safety requirements in motor vehicle construction. In particular rolled sections, which are joined into the pre-form modules of which the pre-form assembly is comprised, must frequently be adapted in the roller profiling segment at the assembly location for adaptation to the welding joining location, so that this is characterized by a high dimensional precision and longitudinally do not exhibit a constant-remaining roller profiled cross-section. By means of the inventive process a very economical pre-form assembly is produced of this type of rolled sections, of which the roller profiled cross-section is variable.

In one advantageous embodiment of the inventive process at least two devices for production of a rolled section are operated in synchrony.

The synchronized interconnecting of at least two devices for production of a rolled section has the advantage, that parallel rolled sections can be produced in the same cycle timing, which leads to a time saving and increased economy of the facility.

It is further possible, without changing the set up, to produce rolled sections with strongly deviating roller profiled cross-sections in, for example, two parallel interconnected devices for production of a rolled section, wherein these are joined into pre-form modules in the device for production of a pre-form assembly. Therewith a time savings is achieved and the unit output is increased.

Alternatively or additionally thereto the devices for production of a rolled section can be interconnected asynchronously and therewith in a discontinuous operation.

In a further embodiment of the inventive process at least two production facilities are operated in synchrony.

The advantage of the synchronized production facilities is comprised therein, that the production facility is operated in synchronized cycles with the device for production of the rolled section in a continuous process. This leads to a savings in intermediate storage and therewith savings in the associated logistical and transportation costs.

Alternatively or additionally thereto, at least two production facilities can be operated asynchronously in order to produce complex roller profiled cross-section variations on certain areas of the rolled section.

In another embodiment of the inventive process there is produced in at least one production facility for further processing of rolled sections at least one cross beam module and/or at least one door sill or rocker panel module and/or at least one longitudinal member or carrier module and/or at least one roof frame module.

The advantage of this design of the inventive process is comprised therein, that one or more production facilities can be designed in such a manner, that the rolled sections can be joined into carrier structures and frame modules with various lengths and/or breadths. Therewith on one production facility, for example, cross beams can be produced with various lengthd and/or breadthd and with various roller profiled cross-sections. This makes possible a saving of complicated set-up changes and increases the economy of the process.

In a further embodiment of the inventive process the blank is cold and/or warm deformed.

The advantage of this design of the inventive process is comprised therein, that the production of rolled sections by cold forming of the blank ensures a very high dimensional truness of the rolled sections. Therewith pre-formed modules with high quality and dimensional truness can be produced economically in higher numbers.

Alternatively or additionally to this the blank can be warm deformed. This has the advantage, that a joining process can be adjusted to adapt to the conditions of employment via the roller profiled cross-section.

In a further embodiment of the inventive process the blank is deformed in two separate work processes in the device for production of a rolled section.

The advantage of this embodiment of the inventive process is comprised therein, that between the two separate work processes of the roller profiling a deformation process, such as for example deep drawing and/or crimping and/or draw or pressure deforming can occur. Therewith another deformation process is integrated in the roller profiling process step. By means of this process roller sections with various widths, lengths and roller section cross-sections can be produced. Thereby rolled sections can be produced, which are exactly adapted to the later intended use and the dimensions of the pre-form module.

In this advantageous embodiment of the inventive process the production of the rolled section, and the production of the changed roller section cross-section, occurs without intermediate storage and the therewith associated logistical and transportation costs.

It is also possible to deform the blank in the device for production of a rolled section in one process operation.

This can occur using conventional or flexible roller profiling in the sense of DE10011755A1. The advantage of the application of the conventional roller profiling is based on the fact that much experience exists in practice.

In another embodiment of the inventive process high strength steel and/or deep draw steel and/or Ti-alloys and/or Ni-alloys and/or light steel and/or metal containing composite materials are employed as the starting material for the blank.

By means of this process a weight reduction is achieved, which is made possible by the increased rigidity of the rolled section, the pre-form module and the pre-form assembly.

Besides the weight reduction, these materials have the advantage that less installation space is needed and, on the other hand, the increasing safety requirements in motor vehicle construction with regard to structure and safety components can be satisfied.

In particular, high strength steels (so called light construction steels), preferably from the group of multi-phase steels, such as for example dual phase steel (DP-Steel), complex phase steel (CP-Steel), material phase steel (MP-W-Steel), LiP-Steel (Light Steel with Induced Plasticity) or TRIP-Steel (Transformation Induced Plasticity), are highly suited for this inventive process.

These steels exhibit particularly beneficial work hardening characteristics, which translates into a desirable deformation/rigidity characteristic. A very high hardening of these steels with high start hardening exhibits itself particularly advantageously in crash behavior. Therewith an increase in rigidity is accomplished in desired rolled section areas, without needing for example the cost intensive heat treatment.

Alternatively, or in addition thereto, deep draw steels can be employed in rolled sections in accordance with the invention, since besides the low carbon content they also have a fine grain, amorphous textured microstructure and exhibit a tensile limit without a yield range.

Also titanium alloys, which have a higher modulus of elasticity than steel, can be processed by deformation techniques using roller profiling to a rigid pre-form assembly. The higher modulus of elasticity has a positive effect on the torsion and flexural rigidity of the rolled section produced by deformation techniques.

It is advantageous to employ, in a pre-form assembly, metal containing composite materials for the rolled sections. The advantage of these materials is comprised therein, that they can be “mass tailored” for the respective employment purpose. Thus, reinforcement can be provided as necessary, for example, only in the highly stressed rolled section areas such as for example the joining locations.

### BRIEF DESCRIPTION OF THE DRAWINGS

In the following the subject matter of the invention will be described in greater detail on the basis of the illustrative embodiment and FIG. 1. There as shown

FIG. 1 schematic representation of the components of a pre-form assembly.

### DETAILED DESCRIPTION OF THE INVENTION

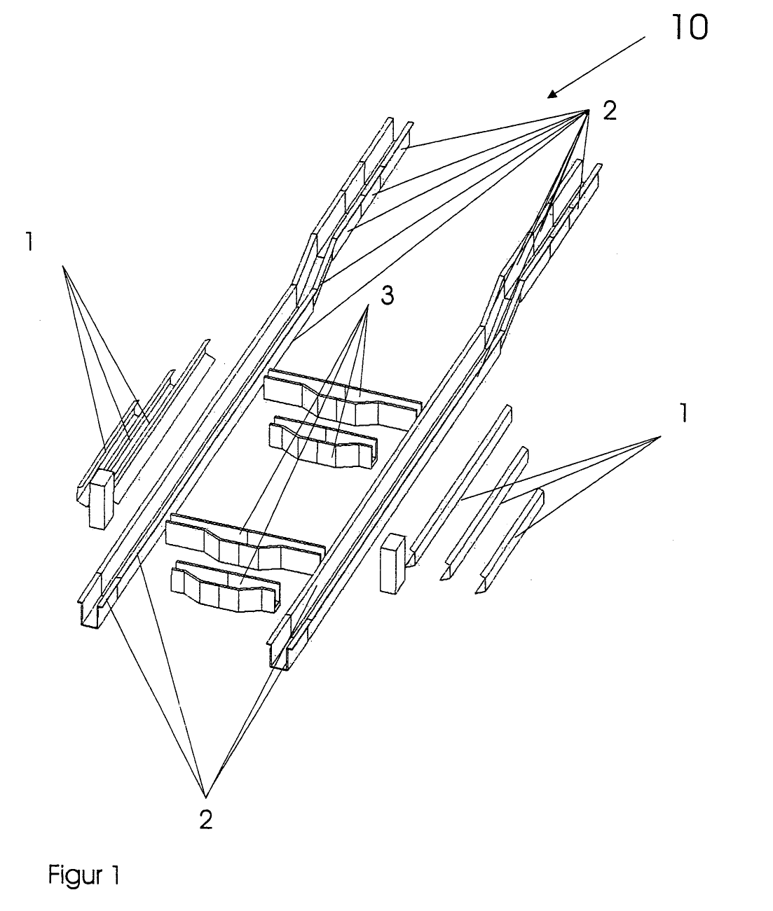

FIG. 1 shows schematically an illustrative embodiment of the inventive pre-form assembly 10. It includes rocker panel or side door-sill modules 1, longitudinal main chassis beams 2 and cross beam module 3. As starting material (sheet metal) for a blank, a TRIP-steel from an unrolling station (coil) is employed. The TRIP-steel is characterized by a high stiffness at high ductility and can be deformed by the inventive process.

In a first process step three blanks are oriented parallel in three devices for production of a rolled section, after which in a next process step they are marked. Subsequently the blanks are, in a third process step, permanently welded with a first rolled section, which is produced in a separately provided production facility for production of components. Therein the joint location lies centrally upon the blanks, in such a manner, that the blanks can be roller profiled in a subsequent step in the area of the blank beside the joint location. In the first device for production of the rolled section a first blank is profiled to a rolled section of the cross beam family; in a second device for production of a rolled section the second blank is roller profiled to a rolled section of the door sill family; and in a third device for production of a rolled section the third blank is roller profiled to a rolled section of the roof frame family. After the first roller profiling step the rolled sections of roller profiled blank are deep drawn in an integrated production facility for deforming, creased and subsequently roller profiled in the device for production of a rolled section in a second roller profiling step. Therein, using the three devices for production of a rolled section, respectively one blank can be roller profiled in a continuous process to a rolled section with a roller profile strongly deviating from the other roller profiles. In order to ensure the desired length of the individual rolled sections, the rolled sections which are roller profiled in the device for production of a rolled section from a blank, subsequent to roller profiling, are separated in an interconnected production facility for separating. Subsequently the roller profiles with high dimensional precision are respectively imparted with holes in an interconnected production facility for forming holes, which is provided in series following the production facility for separating, in order to achieve an improved build-out utility. In the next process step further components, such as for example screws, nuts and rivets are releasably secured to the rolled section or, with additional components, permanently joined in a production facility for further processing of the rolled section into pre-form modules. The production facility for further processing of the rolled section into pre-form modules is provided in-line to the production device for producing holes, and directly after the production facility for roller profiling. Subsequently the parallel produced pre-form modules pass through a production facility for washing, in order to prepare this for a subsequent further processing. In a further production facility, which is subsequent to the production facility for washing, the individual pre-form modules are joined to a pre-form assembly 10.

A control device controls the supplying and joining of the pre-form modules into a pre-form assembly 10, in that it controls the devices for production of rolled sections and the production facilities for further processing of the rolled sections into pre-form modules as needed either synchronized or asynchronously. By the synchronized interconnecting of the devices and the production facilities a coordinated precisely timed production of the pre-form module is ensured, which allows the immediate joining of the pre-formed module into the pre-form assembly 10 without any unnecessary time delay.

In a second embodiment, on each of the three devices for production of a rolled section, roller profiles with strongly divergent roller profiled cross-sections and lengths can be produced. Therein the rolled sections exhibit roller profiled cross-sections differing in height and in breadth, which are produced by means of discontinuous roller profiling. Using the control device, the supplying and joining of the three different pre-form modules into a pre-form assembly 10 is controlled asynchronously. The asynchronous interconnecting of the devices for production of rolled sections on the one hand, as well as the production facility on the other hand, ensures a chronological synchronized production of rolled sections, independent of the number of the process steps in the three devices for production of a rolled section and the three production facilities for further processing of the rolled sections into pre-form modules. Therewith the joining of the rolled sections into pre-formed modules and the pre-formed modules into a pre-form assembly 10 occurs economically and with precise dimensions.

The invention is not limited to the above described embodiments, and in particular is not limited to the above described number of devices for production of a rolled sections and the number of production facilities for further processing of the rolled sections into pre-formed modules. It is also conceivable to have two or more than three devices for production of a rolled section and two or more than three production facilities for further processing of the rolled section into pre-formed modules in parallel. Thus it is, for example, possible to carry out the process steps in the device for production of a rolled section in changed sequence, or not to join a supplemental rolled section with the pre-form module prior to the first roller profiling step, but rather essentially to roller profile the blank in one process step.

Besides this, it is conceivable for the manufacturer of rolled sections to employ a different starting material. For example, in place of TRIP-steels, other steels, for example TWIP-steels can be employed, which at a higher rigidity have a higher deformability. It is also possible to use aluminum or magnesium based alloys as starting material for the blank.

With the inventive process it is also possible to produce other types of pre-form assemblies.

1. A device for producing a pre-form assembly (10) for a vehicle, including:
a device for producing a rolled section and,
a production facility for further processing the rolled section into a pre-form module, wherein the device for producing a pre-form assembly (10) further includes:
at least a second device for production of a rolled section arranged parallel to the first,
at least a second production facility for further processing arranged parallel to the first,
at least one further production facility for joining the pre-form modules into pre-form assemblies (10), and
at least one control device for controlling the supplying and/or joining at least two pre-formed modules into a pre-form assembly (10).

2. The device according to claim 1, wherein the device for producing a rolled section includes at least one integrated production facility for deforming.

3. The device according to claim 1, wherein at least two devices for production of a rolled section are interconnected synchronized.

4. The device according to claim 1, wherein at least two production facilities are interconnected synchronized.

5. The device according to claim 1, wherein the device for producing a rolled section additionally includes at least one interconnected production facility for straightening and/or an interconnected production facility for marking and/or an interconnected production facility for joining and/or an interconnected production facility for crimping and/or interconnected production facility for drawing or pressure forming and/or interconnected production facility for imparting holes and/or an interconnected production facility for washing.

6. A process for production of a pre-form assembly (10) for a vehicle with at least two pre-form modules, including the following coordinated steps:
deforming at least two blanks into rolled sections,
further processing the rolled sections into pre-form modules, wherein
the deforming of the blanks into rolled sections occurs in at least two parallel arranged devices for production of a rolled section,
the further processing of the rolled sections into pre-form modules occurs in at least two parallel arranged production facilities,
a control device is connected to the at least two devices for production of a rolled section and with the at least two production facilities and at least one further production facility and controls these in the manner that coordinated chronologically and spatially the respective pre-form modules are joined to each other into pre-form modules (10) in the further processing facility.

7. The process according to claim 6, wherein at least two devices for production of a rolled section are operated synchronized.

8. The process according to claims 6, wherein at least two production facilities are operated synchronized.

9. The process according to claim 6, wherein in at least one production facility for further processing of rolled sections at least one cross beam module (3) and/or at least one door sill or rocker pannel module (1) and/or at least one main chassis frame module (2) and/or at least one roof beam module is produced.

10. The process according to claim 6, wherein the blank is deformed cold and/or warm.

11. The process according to claim 6, wherein the blank is deformed in two process steps separate from each other in the device for the production of a rolled section.

12. The process according to claim 11, wherein the starting material for the blank is a high strength steel and/or deep draw steel and/or titanium alloy and/or nickel alloy and/or light steel and/or metal containing composite material.
